(19) United States
(12) Patent Application Publication
(10) Pub. No.: US 2010/0268591 A1
(43) Pub. Date: Oct. 21, 2010

(54) SYSTEM AND METHOD FOR SELECTIVELY CONTROLLING THE USE OF FUNCTIONALITY IN ONE OR MORE MULTIFUNCTION DEVICES AND SUBSIDIZING THEIR USE THROUGH ADVERTISEMENTS

(75) Inventors: Shanmuga-Nathan Gnanasambandam, Webster, NY (US); Warren Kleiman, Fairport, NY (US); Jack Douglas Jenkins, JR., Tualatin, OR (US); Dennis C. DeYoung, Webster, NY (US); Russell Neville, Tualatin, OR (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/424,858

(22) Filed: Apr. 16, 2009

(51) Int. Cl. G06Q 30/00; G06Q 50/00; G06Q 20/00; G06Q 10/00; G06F 3/12

(52) U.S. Cl. 705/14.37; 705/41; 705/30; 705/400; 358/1.13

(57) ABSTRACT

A system and related method for selectively controlling use of functionality in one or more multifunction devices includes a communications interface in operative communication with a printer and/or a display apparatus. The communications interfaces electronically communicates data with the printer and/or the display apparatus. The data includes a data structure configured to present an advertisement. The data may be print data or image data. The communications interface is operatively associated with an advertisement-credit component which can generate a credit value corresponding to the advertisement. The advertisement-credit component can subsidize multi-function device costs based upon a presented advertisement, e.g., the cost of printing, scanning, faxing, and related consumables including inks, toners and/or papers. The advertisement credit component authorizes use of a predetermined amount of a function with the credit value that corresponds to the advertisement.

### CROSS-REFERENCE TO RELATED APPLICATION

This application is related to U.S. Patent Application entitled “METHOD AND SYSTEM FOR PROVIDING CONTRACT-FREE “PAY-AS-YOU-GO” OPTIONS FOR UTILIZATION OF MULTI-FUNCTION DEVICES” filed simultaneously herewith, which is incorporated by reference herein in its entirety.

### BACKGROUND

1. Field of the Related Art

The present disclosure relates to document processing systems, such as printing systems, and more particularly, to a system and method for selectively controlling the use of functionality in one or more printers, such as for authorizing use of functionality (e.g., faxing, scanning, copying, printing, the use of consumables, the use of software and the like) on a plurality of multifunction devices (MFDs) within the context of a contract-free “pay-as-you-go” system capable of presenting advertisements (printing, displaying, embedding into scanned images or faxed images, and the like) and subsidizing their use through advertisements.

2. Background of the Related Art

The concept of “network printing,” in which any of a plurality of computers submit digital data to one of any number of printers over a network, is well known. A conventional printing system uses a client/server architecture that usually includes three primary components. These components include (i) a client, (ii) a server, and (iii) an output device. The client conveys print and management requests to the server and receives responses from the server that arise in response to the submitted requests. The server receives these requests from the client, performs the required actions for each request, and returns the responses to the client. One such request from a client is a print request, i.e., a request to print one or more copies of one or more documents, with the printed pages output using one or more features. A print request may represent a collection of one or more documents to be printed, as well as instructions for printing. The server organizes the documents indicated in the print request submitted by the client into a print job. The server then sends the print job and any associated job control commands to an output device.

The output device is a physical device, or hardware, that is capable of rendering images of documents and producing hard copy output of the print jobs received from the server. The output device can then return responses to the server regarding its current state or the status of the received print jobs. The output device is commonly a printer. However, the output device may also be any type of multifunction device (MFD).

In general, a MFD operates as a plurality of different imaging devices, including, but not limited to, a printer, copier, fax machine, and/or scanner. In recent years the basic office copier has evolved into what can be referred to as a MFD. With digital technology, a machine with the basic outward appearance of a traditional copier can perform at least the additional functions of printing documents submitted in digital form over a network, sending and receiving messages via facsimile, recording hard-copy original images in digital form and sending the resulting data over a network, such as in electronic mail and/or recording hard-copy original images in digital form on a compact disc or equivalent medium.

In the area of digital printing and copying, there has been a growth in demand for MFDs. Such MFD devices may assume the form of an arrangement in which a single print engine (e.g., xerographic or thermal ink jet print engine) is coupled with a plurality of different image input devices (or “services”), with such devices being adapted to produce image related information for use by the printer or transmitted over a network. The image related information, in one example, could have its origin in video facsimile signals, microfilm, data processing information, light scanning platens for full size documents, aperture cards, and microfiche. MFDs provide a broader range of functionality than traditional single-function devices, such as dedicated printers, copiers, and scanners. As a result since MFDs are universally used, and since many MFDs can be quite pricey for consumers/customers, it would be useful to enable several users of various economic means to have access to such expensive MFDs on a “pay-as-you-go” basis.

For example, in today's networking environments, long-term contractual agreements and high upfront costs have made some print devices, including MFDs, economically out of reach for several customers. In conventional systems, there is no mechanism to pay low, flexible amounts of money that may depend on seasonal print/usage volume without contractual obligations. Moreover, shipping delays are prevalent when a consumable has to be replenished by a customer for a single MFD or a multitude of MFDs that belong to a fleet of MFDs. Even for a small shipment size there may be a need for the consumer to transport the consumable to the MFD involving a delay. Thus, in networked environments employing a large number of MFDs, it is more economical to operate MFDs on a “pay-as-you-go” basis. Consequently, current systems lack the capability to effectively provide for cheap or economical solutions for customers desiring to use one or more MFDs that may have seasonal demand cycles.

### SUMMARY

The present disclosure relates to document processing systems, such as printing systems, and more particularly, to a system and method for selectively controlling the use of functionality in one or more printers, such as for authorizing use of functionality (e.g., faxing, scanning, copying, printing, the use of consumables, the use of software and the like) on a plurality of multifunction devices (MFDs) within the context of a contract-free “pay-as-you-go” system capable of presenting advertisements (printing, displaying, embedding into scanned images or faxed images, and the like) and subsidizing their use through advertisements.

The present disclosure is intended to overcome the drawbacks of other methods by providing, for example, a system and method for enabling functionality on a plurality of MFDs by utilizing a contract-free “pay-as-you-go” system. The system may be shipped with a significant amount of a consumable, functionality or software shipped with the initial consignment (or at the time of the initial purchase), and/or a service enabling component to selectively control the use of functionality in one or more devices, such as for authorizing use of functionality (e.g., faxing, scanning, copying, printing, the use of consumables, the use of software and the like) on a plurality of multifunction devices (MFDs).

Additionally, the present disclosure is directed to selectively controlling the use of functionality in one or more multifunction devices and subsidizing their use through advertisements. Subsidization refers to offsetting, reducing, or eliminating the cost to use the MFD or service installed on the MFD, such as to print a page, e.g., by subsidizing, one or more of the costs including paper costs, ink or toner costs, or machine cost. More broadly, the machine may be shipped with the capability to perform a variety of functions (toner and other consumables are simply examples of the many parts that interact under the direction of software to perform a service, such as printing a data image onto a sheet of paper).

In one embodiment of the present disclosure, a system for selectively controlling use of functionality in one or more multifunction devices includes a communications interface. The communications interface is in operative communication with a printer and/or a display apparatus. The communications interface can electronically communicate data with the printer and/or the display apparatus. The data includes a data structure configured to present an advertisement. The data is print data and/or image data. The communications interface is operatively associated with an advertisement-credit component. The advertisement credit component generates a credit value corresponding to the advertisement. The advertisement credit component authorizes use of a predetermined amount of a function with the credit value which corresponds to the advertisement. For example, the advertisement credit component may credit an account with the credit value.

The communications interface can operatively communicate the data to the printer such that the printer operatively prints the advertisement on a substrate thereby presenting the advertisement. Additionally or alternatively, the display apparatus is an image viewer and the advertisement is presented via being embedded into a scanned image and/or a faxed image. The embedded image is viewable with the image viewer. For example, the advertisement may be presented to a user when the user scans in an image and the advertisement appears the results of the scan; the image is part of the image file, e.g., a JPEG.

In another embodiment of the present disclosure, the communications interface operatively communicates the data to a display apparatus such that the display apparatus displays the advertisement. The advertisement credit component may generate the credit (e.g., a data structure corresponding to a currency amount) value when a response is received in response to the displayed advertisement presented on the display apparatus, e.g., such as a user pressing a user input device associated with the presented advertisement the user using a kiosk in response to the presented advertisement, the user pressing a touch-sensitive layer in the region of the displayed advertisement as presented on the display, and/or the user utilizing a coupon associated with the presented advertisement as presented on the display apparatus.

For example, advertisements that are utilized for subsidizing the usage of the device could be displayed proactively on the front panel user-interface (the display apparatus) of the device even if it is not linked to any printer or user characteristic and/or is not triggered by the user in any way. The touch screen could enable the user to link through the internet to a web site which could then potentially use the whole screen to interact with the customer. The advertisement could also be an attention grabbing multimedia presentation, or could include a link to printable documents such as advertising brochures. Such advertisements can operatively generate credits for the customer without being explicitly tied with a certain printed advertisement. The printing of the linked pages could be free for the customer but may be charged incrementally to the advertiser. For example, the advertisement on the front panel may be for a car. The user touches the link to print the brochure. A full-color brochure prints on the device. The user machine could be credited 2 cents to cover the paper. The printed advertisement would not count as chargeable for the customer in this example. The advertiser could be charged for the cost of consumables used plus a premium.

The function that may be selectively controlled may be scanning, copying, faxing, the use of a consumable and the use of software functionality. The software functionality may be image processing, image modification, image editing, image cropping, image contrast adjustments, image hue adjustments, image red-eye removal, and/or image color balancing.

In yet another embodiment of the present disclosure, the system includes a disabling component. The disabling component can disable use of a multifunction device when an account exceeds a predetermined usage (e.g., a negative balance, overcharges, overage of daily or monthly limits, and the like). The disabling component can enable the disabled multifunction device when the disabling component receives an encrypted authorization, e.g., when the manufacturer of the MFD or the system sends the disabling component a message after the negative account balance has been remedied.

For example, a pay-as-you-go system can be utilized in a contract-based business model under conditions where the contract has been violated or exceeded. A device, such as a printer or a MFD, can be sold to a customer under a n-year contract with a license fee of $x/month for authorization to use 1000 color pages, 5000 black pages and 1000 scans. If during a particular month, the agreed thresholds are exceeded (e.g., an account, such as the contract account, exceeds a predetermined usage), then the disabling component in the system may shut down (i.e., disable) functionality in the device until an overage charge is paid. An automatic deduction from a prepaid account may occur, or the overage may be billed in a conventional way, but regardless, a business rule in the disabling component can determine when to enable or disable the functionality of the device, e.g., in this example when to enable the disabled functionality upon receipt of payment. Furthermore, the presented advertisements can be used to subsidize the costs for the customer, for example, by not counting pages with printed advertisements towards the abovementioned monthly limit.

In another embodiment of the present disclosure, the predetermined amount of the function is a predetermined amount of an initial amount of a preloaded consumable (e.g., a device may be shipped with a preloaded amount of toner). The initial amount of the preloaded consumable may be greater than an authorized amount of the consumable.

The system may include an application. The application communicates with said communications interface for receiving information from an inputted code. The information can include a financial value with which usage of a second predetermined amount of the initial amount of the preloaded consumable is authorized. The inputted code operatively activates said application for authorizing usage of the second predetermined amount of the initial amount of the preloaded consumable. The inputted code is may be operatively encoded on a prepaid card such that the application operatively receives the inputted code from the prepaid card. The credit value can be applied to the cost of the prepaid card thereby operatively crediting the account the credit value.

In another embodiment, the system further includes an advertisement-communications component. The advertisement-communications component is adapted to receive an initial advertisement data structure from a server and an initial print job. The advertisement communications component operatively generates the print data including the data structure utilizing the initial advertisement data structure and the initial print job. The advertisement-communications component operatively communicates the print data to the communications interface.

In yet another embodiment of the present disclosure, system further includes a server and a data store (e.g., a database, memory, a disk drive, RAN, ROM, and the like). The server is in operative communications with a plurality printers and/or a plurality of display apparatuses. The plurality of printers includes the abovementioned printer and the plurality of display apparatuses includes the abovementioned display apparatus. The server is adapted to operatively communicate a plurality of data structures to one of the plurality of printers and/or one of the plurality of display apparatuses. The plurality of data structures includes the data structure configured to present the advertisement.

The data store is in operative communication with said server and is adapted to store a plurality of characteristics of the plurality of printers and/or the plurality of display apparatuses. The server selectively communicates each of the plurality of data structures to a selected printer of the plurality of printers and/or a selected display apparatus of the plurality of display apparatuses as a function of one of the plurality of characteristics.

The data structure may also include a device ID, an end user, a job characteristic, a image characteristic, a location of the one of the selected printer and the selected display apparatus, the characteristic of the one of the print data and the image data, a use of the selected printer, and/or a use of the selected display apparatus.

In yet another embodiment of the present disclosure, the system may also include an advertisement submission subsystem communicating with said server for submitting the plurality of data structures to said server. The advertisement submission subsystem associates at least one advertisement characteristic with each of the plurality of data structures. The server selectively communicates each of the plurality of data structures to the selected printer and/or the selected display apparatus as a function of one of the at least one advertisement characteristic associated with the selected one of the plurality of data structures. The at least one advertisement characteristic can include a desired dimension, a desired resolution, a desired color requirement, a desired location, a desired number of printed advertisements, a prohibited advertisement location type, a desired paper quality and/or an advertisement type. The advertisement type may be an automobile advertisement, a healthcare advertisement, and/or an insurance advertisement. Additionally or alternatively, the selected printer may be selected as a function of a printer-location type, a printer-location human-traffic value, a printer capability, a printer output volume, a printed material parameter, a printer characteristic, a user characteristic and/or a job characteristic.

In yet another embodiment of the present disclosure, the system includes a fleet configuration component. The fleet configuration can configure at least one parameter of the one or more parameters of the printer and/or the display apparatus such that (a) the printer prints the advertisement on the substrate in accordance with the at least one parameter and/or (b) the display apparatus displays the advertisement in accordance with the at least one parameter. The parameters may include: a maximum allowable dimension, a minimum allowable dimension, a maximum allowable resolution, a minimum allowable resolution, a color requirement, a cost per advertisement, a cost per pixel, a cost per printed area, a location, a minimum bid per advertisement, a minimum number of total printed advertisements, an allowable advertisement type and/or a prohibited advertisement type. The allowable advertisement type and the prohibited advertisement type may be selectable to an advertisement type including an automobile-type advertisement, a healthcare-type advertisement, and/or an insurance-type advertisement.

In yet another embodiment of the present disclosure, a a method for selectively controlling use of functionality in one or more multifunction devices includes: (i) communicating data to at least one of a printer and a display apparatus, wherein the data includes a data structure configured to present an advertisement; (ii) presenting the advertisement; (iii) generating a credit value corresponding to the presented advertisement; and (iv) authorizing use of a predetermined amount of a function with the credit value.

The method may also include: (v) determining a financial value from information stored on a prepaid card; and (vi) authorizing usage of a second predetermined amount of the function, the second predetermined amount having a license value about equal to the financial value. (ii) from above may include: (vii) printing the advertisement on a substrate with the printer; and/or (viii) displaying the advertisement on the display apparatus.

### BRIEF DESCRIPTION OF THE DRAWINGS

Various embodiments of the present disclosure will be described herein below with reference to the figures wherein:

FIG. 1 is a schematic diagram of a flexible and incremental payment process of the “pay-as-you-go” purchase system of FIG. 2, in accordance with the present disclosure;

FIG. 2 is a schematic diagram of a “pay-as-you-go” purchase system, in accordance with a first embodiment of the present disclosure;

FIG. 3 is a sequence diagram for a plurality of transactions conducted in the “pay-as-you-go” purchase system of FIG. 2, in accordance with the present disclosure;

FIG. 4 is a flow chart illustrating a method for enabling printing to a plurality of multifunction devices (MFDs) via the “pay-as-you-go” purchase system of FIG. 2, in accordance with the present disclosure; and

FIG. 5 is a schematic diagram of a “pay-as-you-go” purchase system including an advertisement deduction process, in accordance with a second embodiment of the present disclosure.

### DETAILED DESCRIPTION

The present disclosure proposes a system and method for enabling printing on a single MFD or a plurality of MFDs (i.e., a fleet of MFDs) while securely paying for the printing through flexible, small installments at a time of the customers' choosing. In addition, shipping delays associated with consumables may be reduced or even entirely eliminated by the exemplary embodiments of the present disclosure.

The present disclosure further proposes that at the time of initial purchase of the MFDs, a reasonable amount of consumables, such as toner or any other type of consumable(s) related to MFDs, are shipped along with the initial shipment of each MFD of the plurality of MFDs at no additional cost to either the manufacturer or the purchaser of the MFDs. The amount of consumables may be such that it is enough to enable printing through the estimated lifetime of the printer for, say, 95% of the customers for that specific MFD type.

The present disclosure further proposes that without explicit authorization from the manufacturer (e.g., Xerox® or any other service provider or any other controller of the plurality of MFDs) the MFDs would not print or perform any other type of operation (such as scanning, faxing, etc). In other words, constant and continuous authorization is required for the usage of the MFDs by the users of the plurality of MFDs from the controller/operator/owner and/or service provider of the plurality of MFDs.

The present disclosure further proposes that the authorization can be applied to a multitude of MFDs at the customer's end via a manufacturer supplied software application that will accept a code, say, from a “value-card” like entity to hold a selected financial value relating to consumables. The consumer may buy the “value-card” through any conventional means (e.g., physical or electronic) and, as such, the modality of purchase does not affect the exemplary embodiment of the present disclosure.

The present disclosure further proposes that a page counter that counts down using actual printed volume by pages or page coverage by pixels deposited is used to measure usage. The page-counter can be securely incremented whenever a payment is authorized. A life-time counter may also be maintained within the controller, which is decremented by the same amount the page-counter is incremented at the time of payment authorization. This usage based printing mechanism can be enabled in an denomination at the discretion of the manufacturer of the pay-go device. For example, people can buy and/or be billed at a half page, 25% pixel coverage, the like, and combinations thereof.

The term “print” is overloaded to mean sending the document to the printer through any one of a multitude of ways. Moreover, the term “printer” can refer to any device that accepts text and graphic output from any type of computing device and transfers the information to any printable medium. A “printer” can refer to any type of xerographic, solid ink, liquid ink, cut sheet or web-based device used to print onto a wide array of printable media. The term “printer” as used herein encompasses any apparatus, such as a digital copier, bookmaking machine, facsimile machine, multi-function machine, etc. which performs a print outputting function for any purpose.

MFDs disclosed herein include both those that are “connected” and those that are “unconnected.” An “unconnected” MFD does not have access to a network (e.g., the Internet). A “connected” MFD is normally connected via an Ethernet card or the like to a network. In the present embodiments, the MFD may be an unconnected MFD that is in operative communication with a wireless device, the wireless device being able to access a network. A connection between the multifunctional device and the wireless device is made through a two-way communication channel located on the multifunctional device.

The term “MFD” can refer to any machine that connects to either a computing device and/or network and performs one or more of the following functions: print, scan, copy, and/or fax. Digital copiers, fax machines, printers, and scanner combinations are all examples of MFDs. The term “MFD” can further refer to any hardware that combines several functions in one unit. For instance, an MFD can be a standalone printer or any type of standalone machine/device/apparatus/component. For example, an MFD can be one or more personal computers (PCs), a standalone printer, a standalone scanner, a mobile phone, an MP3 player, audio electronics, video electronics, GPS systems, televisions, recording and/or reproducing media (such as CDs, DVDs, camcorders, cameras, etc.) or any other type of consumer or non-consumer analog and/or digital electronics. Such consumer and/or non-consumer electronics can apply in any type of entertainment, communications, home, and/or office capacity. Thus, the term “MFDs” can refer to any type of electronics suitable for use with a circuit board and intended to be used by a plurality of individuals for a variety of purposes.

The term “storage” can refer to data storage. “Data storage” can refer to any article or material (e.g., a hard disk) from which information is capable of being reproduced, with or without the aid of any other article or device. “Data storage” can refer to the holding of data in an electromagnetic form for access by a computer processor. Primary storage is data in random access memory (RAM) and other “built-in” devices. Secondary storage is data on hard disk, tapes, and other external devices. “Data storage” can also refer to the permanent holding place for digital data, until purposely erased. “Storage” implies a repository that retains its content without power. “Storage” mostly means magnetic disks, magnetic tapes and optical discs (CD, DVD, etc.). “Storage” may also refer to non-volatile memory chips such as flash, Read-Only memory (ROM) and/or Electrically Erasable Programmable Read-Only Memory (EEPROM).

The term “software application” can refer to any type of tool that functions and is operated by means of a computing device/component, with the purpose of supporting or improving the software user's work/tasks. The term “software application” can also refer to a subclass of computer software that employs the capabilities of a computer directly and thoroughly to a task that the user wishes to perform. The term “software application” can further refer to a program or group of programs designed for end users. Application software can include any type of database programs, word processing programs, and/or spreadsheet programs.

The term “activating element” can refer to a prepaid card. The term “activating element” may refer to pieces of paper marked in various ways and used for conducting financial and/or business transactions and/or a piece of plastic of any size that serves as the physical platform for such technologies as bar codes, micro chips, and magnetic stripes. The term “activating element” may further refer to any small, high capacity, high-security flash memory card that provides data storage and Input/Output (I/O) access in a variety of electronic devices. Additionally or alternatively, “activating element” may refer to an active or passive RFID tag or device.

The term “pay-as-you-go” may refer to a time-periodic payment, such as daily weekly, monthly, bi-monthly, quarterly, etc. payment(s). The fee could be a fixed fee or an adjustable fee based on the number of pages printed or based on user operations. Thus, the fee could be a changeable fee based on use or any other desirable parameter(s). The term “pay-as-you-go” may also refer to a system or practice of paying debts as they are incurred. The term “pay-as-you-go” may also refer to a type of service subscription which allows MFD owners/operators/controllers to pay in advance for print jobs or pay for print jobs printed on a time-periodic basis, and add more funds as needed, by day, week or month. Of course, the “pay-as-you-go” system is not limited to print jobs. It may apply to any user tasks/operations, such as, but not limited to, scanning, faxing, etc. The “pay-as-you-go” services may require no contract and no sign-up fees.

The term “virtual” refers to existing in essence or effect though not in actual fact and/or not concrete or physical. The term “virtual” may also refer to something (such as an entity or an item) that has no physical basis itself but mimics a physical object in conceptual terms and/or something occurring or existing primarily on the Internet, such as a virtual card. The term “virtual card” may refer to a credit/debit/payment card that generates a virtual card number each time a user makes a transaction online so that the user doesn't have to use his/her personal debit or credit card number. In this context, a “virtual card” may refer to one or more numbers used across a fleet of MFDs for repurchasing, for example, consumables. Typically, the MFD has a user interface (referred to herein as “UI”). The user interface may be a LCD screen (e.g., a touch screen) a front panel monitor or other display device operatively associated with the MFD. The UI may considered (or be part of) a digital front end. Additionally or alternatively, the UI may operatively communicate with the with the digital front end. The MFD's UI may also be remote (e.g., on a terminal, on a PC) and/or may be any device which is capable to communicating either user input and/or machine output.

Embodiments will be described below while referencing the accompanying figures. The accompanying figures are merely examples and are not intended to limit the scope of the present disclosure.

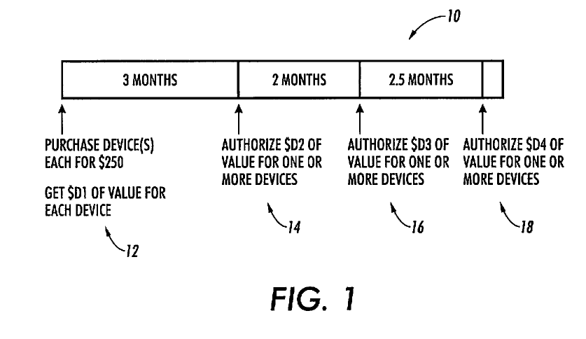

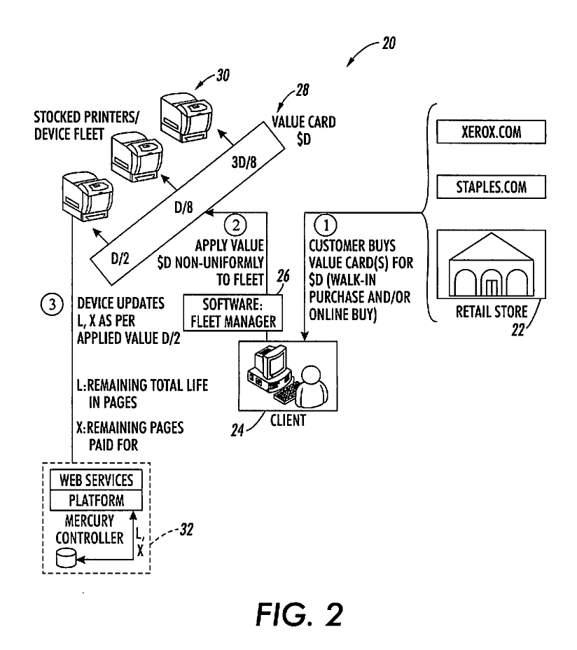

With reference to FIG. 1, there is presented a schematic diagram of a flexible and incremental payment process of the “pay-as-you-go” purchase system of FIG. 2, in accordance with the present disclosure. The payment system 10 includes a first purchase 12, a first authorization 14, a second authorization 16, and a third authorization 18.

FIG. 1 illustrates how a user purchases one or more MFDs via a first purchase 12 at, say, $250. Once the user completes the first purchase 12, the user receives a first value, $D1 on a prepaid card that relates to each of the MFDs purchased. In other words, each MFD has a first pre-set value associated with it or a fleet of MFDs may have a pre-set value associated with them. The first pre-set value is reduced each time a user requests a print job from the MFD. However, the user may purchase an additional prepaid card or deposit additional payments to the existing prepaid card in order to use the MFD or the plurality of MFDs.

For example, after a three month period, the user may complete a first authorization 14, where the user authorizes a second value, $D2, for one or more MFDs, as shown in FIG. 1. After a five-month period, the user may complete a second authorization 16, where the user authorizes a third value, $D3, for one or more MFDs. After a 7.5 month period, the user may complete a third authorization 18, where the user authorizes a fourth value, $D4, for one or more MFDs. In other words, after certain time periods, the user is permitted to add value (e.g., $D2, $D3, $D4) via a prepaid card to one or more desired MFDs. The user has the option to add value to any of the MFDs he/she desires. Thus, the prepaid card can be used for select MFDs based on usage considerations.

In an exemplary embodiment of the present disclosure, the system is referred to as a stocked printer scenario system (see FIG. 2). In such a scenario, the MFDs and their stock of consumables are transported to the customer in one-shot at the time of purchase. It is expected that the weight of the shipment with the consumables may not rise significantly to affect shipping cost, at least in comparison to the several one-way shipments and/or retailing costs incurred in the traditional case. Once the MFDs and consumables are available at the customer's location, the customer could activate more of the stocks by providing more payment, as described above with reference to FIG. 1.

The payment itself is in the form of a “value-card” that is purchased using conventional methods from any retail stores or websites or any type of service providers. Unless such payment is received, the MFDs would cease to function and/or degrade in functionality after the activated supplies on the MFD are depleted. The value in the prepaid card may be applied to more than one MFD such as those in an MFD fleet at the customer location. The ratio of such value application may be uniform or non-uniform as desired by the customer. In other words, a user may apply a portion of the funds to one MFD and apply other portions of the funds to other MFDs. For example, more of a card's value may be applied to a heavily used printer. Thus, the prepaid card can be used on a number of different MFDs in different financial increments.

With reference to FIG. 2, there is presented a schematic diagram of a “pay-as-you-go” purchase system, in accordance with a first embodiment of the present disclosure. The “pay-as-you-go” system 20 includes one or more retail stores 22, a client 24, a software application 26, a value card 28, a plurality of MFDs 30, and a platform 32.

FIG. 2 illustrates how the client 24 communicates with the plurality of MFDs 30 via a software application 26 in order to print one or more print jobs to the plurality of MFDs 30. In this exemplary embodiment of the present disclosure, it is assumed that the client 24 has by some means already acquired the value card 28 and is attempting to securely activate the value card 28 and apply it to one or more of the plurality of MFDs 30 in a customizable or proportionate manner.

In an initial step 0, the user buys SD worth of value (with $ value and embedded code) in the form of a value card 28 dispensed directly from a retail store 22, such as, but not limited to Staples®. Alternately, a virtual card may be supplied by vendors such as Xerox® on www.xerox.com or any other website. However, any type of service provider may supply physical value cards at their retail store or on the Internet via any type of Internet site.

In step 1, the customer opens a software application 26 referred to as a Fleet/Device Manager and keys in the number(s) provided on the value card 28. The card values are verified by, for example, www.Xerox.com or any other other service provider providing such services, which sends confirmation to the software application 26 that the value card 28 has a certain amount of unapplied value.

In step 2, the Device/Fleet Manager or software application 26, which has knowledge of all the plurality of MFDs 30 in scope, applies the value within the value card 28 to the plurality of MFDs 30 themselves. At this point, the serial numbers of the plurality of MFDs 30, with the “pay-as-you-go” service enabled, are transmitted to an enterprise system (e.g., Xerox® through any Xerox® related, owned, operated website or any other service provider website) along with the fraction of $D that is requested to be applied to each device. This however does not limit the key pair exchange and storage process from occuring at a time later than manufacturing. For example, this could occur when the MFD is first set up or configured. Furthermore, known techniques for secure key exchange may be utilized.

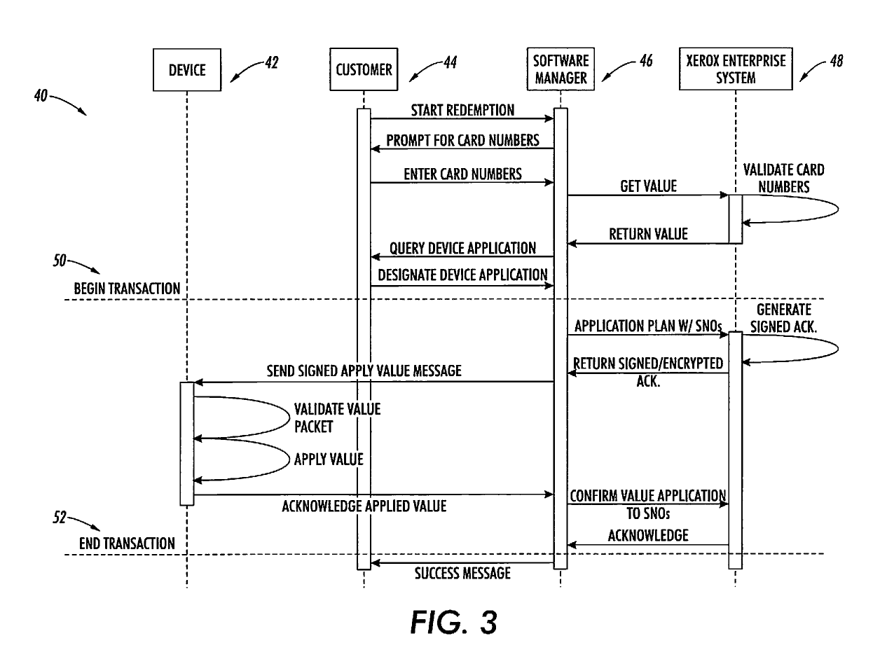

At the time of manufacturing of the MFD, an MFD specific key-pair may have been generated and stored that can be used to enable a secure transaction between the customer, the manufacturer and/or service provider, and the plurality of MFDs 30, which will further be described with reference to FIG. 3. The enterprise information system, which is coupled with the manufacturing process, (i) identifies the MFD serial number specific key, (ii) signs the message containing the serial number, and (iii) sends it back to the device/fleet manager or software application 26. In addition, a specific fraction of the total value that could be applied to an MFD may also be part of the acknowledgement package.

In step 3, the device/fleet manager or software application 26 cannot directly use the signed package, since the plurality of MFDs 30 have other keys belonging to their specific pair. The device manager or software application 26 sends the signed packages associated with each MFD of the plurality of MFDs 30 along with the amount that is requested to be applied. The MFD of the plurality of MFDs 30 securely verifies that the request is valid and applies the change to the MFD.

In the present disclosure, an equivalent number of pages corresponding to d₁% of D may be applied to the first MFD. For example, if the price/page for monochrome is $m/page (ignoring color at this point), then dᵢ% of D/m pages is applied to the i^{th} device. Note that sum (di) is a total of 100%. The argument is easily extended to a combination of color and black and white pages. Let xᵢ be the number of pages that are bought by the i^{th} device (after all associated conversion as above) in a given transaction. This xᵢ is added to the variable x denoting remaining pages that can be printed in the controller of the i^{th} device.

This process is executed for every selected device i belonging to the fleet and subscribed to the “pay-as-you-go” service. In this way, the value of a card 28 can be applied to a plurality of MFDs 30 in a secure manner either uniformly/proportionately or non-uniformly. The variable corresponding to remaining life-time (L) of each MFD is decremented by its corresponding xᵢ during the transaction. If L is less than or equal to zero, the life-time of the MFD has expired and no more authorizations are possible. However, a user of the plurality of MFDs 30 may purchase more value cards 28 or may apply additional payments to the existing value card 28 in order to continue utilizing the plurality of MFDs 30.

While the above description with reference to FIG. 2 is a page based costing model, the value applied to the plurality of MFDs 30 may also be on the basis of a pixel based page coverage model. For example, nearly blank pages with very little pixel coverage may not count as a full page. It is possible to account for fractional pages, for example, during the printing of a given document a series of documents or through an entire time-period. Under such local tracking, the decrements to already activated page counts may happen at a lower rate. Alternately, the value from a value card 28 may directly be applied on the basis of coverage per page. The cost model could also be a combination of page- and pixel-coverage-based techniques.

In step 4, once all the selected MFDs 30 are replenished, a confirmation is sent to the manufacturer and/or service provider to indicate that the card numbers are no longer valid. If the customer desires, a confirmation is printed or emailed directly from the manufacturer and/or service provider.

With reference to FIG. 3, there is presented a sequence diagram for a plurality of transactions conducted in the “pay-as-you-go” purchase system of FIG. 2, in accordance with the present disclosure. The sequence diagram 40 includes an MFD 42, a customer 44, a software manager 46, a remote server 48, a beginning transaction stage 50, and an ending transaction stage 52.

FIG. 3 illustrates a sequence diagram 40 of how such a transaction, as described with reference to FIG. 2, is implemented. FIG. 3 depicts a customer 44 who has access to a software manager 46 for determining access to an MFD 42. The software manager 46 may be electrically connected to a remote server 48, such as a Xerox Enterprise System. However, it is contemplated by one skilled in the art that the remote server may be owned, controlled, and/or operated by any of a number of different service providers.

The customer 44 sends a request to the software manager 46 for permission to access the MFD 42. The software manager 46 prompts the customer 44 for a card number. The customer 44 enters a card number, which is automatically sent to the software manager 46. Optionally, the software manager 46 electronically communicates with the remote server 48 to get the value of the card. The remote server 48 then returns a value of the card back to the software manager 46. The software manager 46 queries the device application from the customer 44. The customer 44 then designates the device application and informs the software manager 46 of such designation. This process completes the beginning transaction stage 50 of the sequence diagram 40.

The ending transaction stage 52 of the sequence diagram 40 commences as follows. Optionally, the software manager 46 sends an application plan with serial numbers (SNOs) of devices to the remote server 48. The remote server 48 generates a signed acknowledgment and returns the signed acknowledgment in an encrypted form back to the software manager 46. The software manager 46 sends the value message to the MFD 42. The MFD 42 validates the value packet and applies the value to the card. The MFD 42 then sends an acknowledgment to the software manager 46 that the value has been applied to the card. The software manager 46 sends a confirmation to the remote server 48 to confirm the value application to the SNOs. The remote server 48 sends a message to the software manager 46 that the confirmation has been acknowledged. The software manager 46 then informs the customer 44 that the message has been successfully received and that the customer is permitted to access the MFD 42.

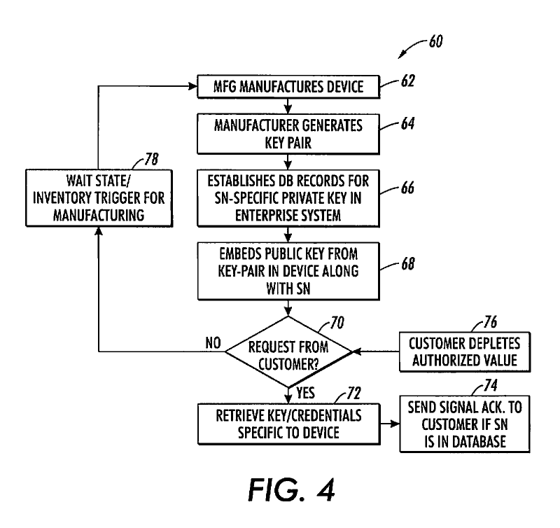

With reference to FIG. 4, there is presented a flow chart illustrating a method for enabling printing to a plurality of multifunction devices (MFDs) via the “pay-as-you-go” purchase system of FIG. 2, in accordance with the present disclosure. By way of example, it also shows how key-pairs are embedded in devices that are manufactured and when there is demand for a pay-as-you-go printer in the market. The flowchart 60 includes the following steps. In step 62, the manufacturer manufactures a device, such as an MFD. In step 64, the manufacturer generates a key pair. In step 66, database records are established for an SN-specific private key in the remote server 48 (i.e., the enterprise system). In step 68, the public key is embedded from the key-pair in the MFD along with the SN-specific key. In step 70, a decision is made whether the customer request should be enabled. If yes, then the process flows to step 72. If no, the process flows to step 78. In step 72, key/credentials specific to the MFD are retrieved. In step 74, a signed acknowledgment is sent to the customer if the SN-specific key is in the database. In step 76, the customer depletes the authorized value. In step 78, a wait state is triggered to halt/restart subsequent production, as a function of demand of MFDs, in the absence of which such MFDs in the field just proceed with the other loop in the flowchart, namely, that of reauthorization upon depletion of resources. The process then ends.

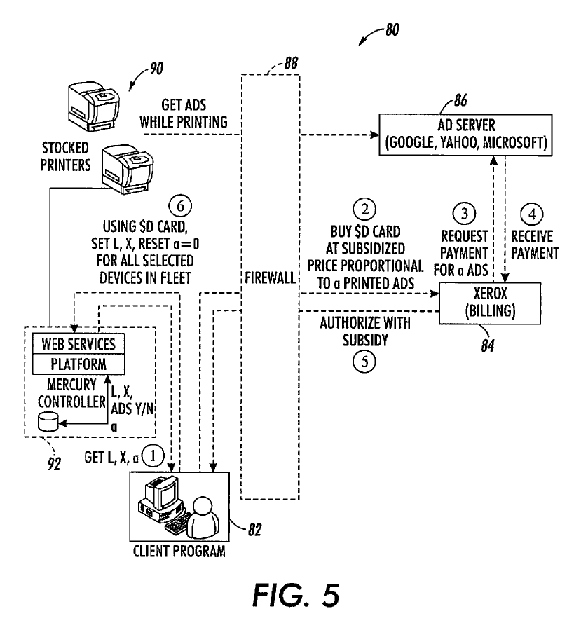

With reference to FIG. 5, there is presented a schematic diagram of a “pay-as-you-go” purchase system including an advertisement deduction process, in accordance with a second embodiment of the present disclosure. The “pay-as-you-go” system 80 includes a client program 82, a billing station 84, an advertisement server 86, a firewall 88, a plurality of MFDs 90, and a platform 92.

FIG. 5 illustrates how a “pay-as-you-go” purchase system is implemented in accordance with a second embodiment of the present disclosure. The client program 82 is in electrical communication with a firewall 88 that directly communicates with a billing station 84 and an advertisement server 86. The client program 82 is permitted to access the plurality of MFDs 90 via a platform 92 when it has been determined that access is permitted.

In the first embodiment of the present disclosure, described with reference to FIG. 1, the customer pays for the complete dollar value of the card that was applied to a fleet of MFDs. However, in the second embodiment of the present disclosure, it is contemplated that there may be cases, especially in places such as airports, museums, train stations, etc. where printing using a fleet of MFDs may be subsidized by advertisements.

In FIG. 5, a case is illustrated where the MFD keeps track of one or more advertisements obtained and printed, and during the time of the next application of value from the card, a discount is provided. The second embodiment improves upon the stocked printer scenario shown in FIGS. 1-4. The extra steps involved in the process described in FIG. 5 would be a) to track the type and quantity of advertisements printed by every MFD in the fleet of MFDs, b) to get a payment from the advertisement aggregator for the ads printed, and c) to give a discount on the actual value of the card that is authorized as in the aforementioned usage case. Advertisements are printed at the discretion of the fleet of MFDs owner/operator, and on specified regions on the paper used by the fleet of MFDs. The customer does not pay for any ad-related expenses. Additionally, the fleet of MFDs may have extra fields to track the ads that are printed.

The advantage of such an implementation, as described in FIG. 5, is that ads may subsidize printing on demand and no special purpose stationary (e.g., the tickets at airports, stations, museums with pre-printed ads, etc.) is necessary. Regular paper can be used and the customer reaps the benefits based on on-demand contextual advertisements.

Moreover, the value card may be purchased using any conventional means. The discounts may be realized through the fleet-manager application which is operated from inside the customer's network in connection with any remote server provided by any service provider. For example, on noticing that the fleet of MFDs has printed a certain volume of advertisements, the value $D in the card may be increased after the application communicates to and authorizes additional value (e.g., proportional to printed ad-volume over the previous time-period) from the remote server provided by any service provider.

The present disclosure proposes an alternative method that takes advantage of “pay-as-you-go” systems relating to printing jobs of MFDs in order to make the process of printing simple and as streamlined as possible to provide for an efficient user experience. The concept of using a “pay-as-you-go” system is a general concept in that it can be used for applications other than printers by any service provider. For example, service providers could use any type of printer and/or MFD and/or electronic device to achieve the desired results of the present disclosure. Also the printing system of the present disclosure makes it easier for information technology (IT) groups and/or service providers to manage the printing environment for their clients.

In summary, the present disclosure introduces a system and method for using a single MFD or a fleet of MFDs while making small, flexible, payments relating to the amount of consumables required without any contractual obligations. The proposed method has the following advantages: (1) Aforementioned contract-free flexible payments at the time of the owner's choosing to account for seasonal demands as foreseen by the owner and/or user of the MFD or the fleet of MFDs; (2) Practically no shipping of consumables (and hence no waiting for the toner to arrive) as the MFD is pre-supplied with consumables along with the initial shipment; and (3) No explicit need to monitor (and inform the manufacturer of) the levels of consumables, causing a communication between the device and the manufacturer across the firewall, unless the customer so desires. All these advantages of the present disclosure may be realized by any service provider.

A service provider can be any entity that develops, offers, controls, manages, owns, alters and/or sells software and/or hardware products. A service provider can be any entity that performs one or more tasks on one or more pre-existing MFDs, which may or may not be controlled or owned by the service provider. For example, the entity can offer a service with an existing software package and/or with any type of existing Internet-based service through the Internet. In other words, a service provider need not own or provide the MFDs. The MFDs may be owned or provided by any third party not related or associated with the service provider. In the present disclosure, it is contemplated that the entity (such as a service provider) can offer any type of service and/or product to optimize pre-existing, pre-owned MFDs by referring potential customers to an Internet website or a store that may or may not be associated with printing-related services and/or products. The term “entity” can refer to anything that may exist as a discrete and/or distinct unit that owns, operates, manages, and/or controls one or more of a plurality of machines (such as MFDs). For example, the term “entity” may include the term “company.”

The present disclosure also includes as an additional embodiment a computer-readable medium which stores programmable instructions configured for being executed by at least one processor for performing the methods described herein according to the present disclosure. The computer-readable medium can include flash memory, CD-ROM, a hard drive, etc.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for selectively controlling use of functionality in one or more multifunction devices, the system comprising:
a communications interface in operative communication with at least one of a printer and a display apparatus, and adapted to electronically communicate data therewith, wherein the data includes a data structure configured to present an advertisement, wherein the data is at least one of print data and image data; and
said communications interface being operatively associated with an advertisement-credit component, said advertisement credit component being adapted to generate a credit value corresponding to the advertisement, said advertisement credit component authorizing use of a predetermined amount of a function with the credit value corresponding to the advertisement.

2. The system according to claim 1, wherein the communications interface operatively communicates the data to the printer, and the printer operatively prints the advertisement on a substrate thereby presenting the advertisement.

3. The system according to claim 1, wherein the display apparatus is an image viewer and the advertisement is presented via being embedded into at least one of a scanned image and a faxed image, the embedded image is viewable with the image viewer.

4. The system according to claim 1, wherein the communications interface operatively communicate the data to a display apparatus, and the display apparatus displays the advertisement thereby presenting the advertisement.

5. The system according to claim 4, wherein the advertisement credit component generates the credit value when a response is received in response to the displayed advertisement presented on the display apparatus.

6. The system according to claim 5, wherein the response is one of a user pressing a user input device associated with the presented advertisement, the user using a kiosk in response to the presented advertisement, the user pressing a touch-sensitive layer in the region of the displayed advertisement as presented on the display, and the user utilizing a coupon associated with the presented advertisement as presented on the display apparatus.

7. The system according to claim 1, wherein the function is one of scanning, copying, faxing, the use of a consumable and the use of software functionality.

8. The system according to claim 7, wherein the software functionality is one of image processing, image modification, image editing, image cropping, image contrast adjustments, image hue adjustments, image red-eye removal, and image color balancing.

9. The system according to claim 1, further comprising:
a disabling component to disable use of a multifunction device when an account exceeds a predetermined usage, wherein said disabling component enables the disabled multifunction device when said disabling component receives an encrypted authorization.

10. The system according to claim 1, wherein the credit value is a data structure corresponding to a currency amount.

11. The system according to claim 1, wherein the predetermined amount of the function is a predetermined amount of an initial amount of a preloaded consumable.

12. The system according to claim 11, wherein the initial amount of the preloaded consumable is greater than an authorized amount of the consumable.

13. The system according to claim 11, the system further comprising:
an application communicating with said communications interface for receiving information from an inputted code, the information including a financial value with which usage of a second predetermined amount of the initial amount of the preloaded consumable is authorized, wherein the inputted code operatively activates said application for authorizing usage of the second predetermined amount of the initial amount of the preloaded consumable.

14. The system according to claim 13, wherein the inputted code is operatively encoded on a prepaid card, wherein the application operatively receives the inputted code from the prepaid card.

15. The system according to claim 14, wherein the credit value is applied to the cost of the prepaid card thereby operatively crediting the account the credit value.

16. The system according to claim 1, where said advertisement credit component credits an account with the credit value.

17. The system according to claim 1, the system further comprising:
an advertisement-communications component adapted to receive an initial advertisement data structure from a server and an initial print job, wherein the advertisement communications component operatively generates the print data including the data structure utilizing the initial advertisement data structure and the initial print job, wherein the advertisement-communications component operatively communicates the print data to the communications interface.

18. The system according to claim 1, the system further comprising:
a server in operative communication with at least one of a plurality printers and a plurality of display apparatuses, the plurality of printers includes the printer and the plurality of display apparatuses includes the display apparatus, wherein said server is adapted to operatively communicate a plurality of data structures to the at least one of the plurality of printers and the plurality of display apparatuses, wherein the plurality of data structures includes the data structure configured to present the advertisement;
a data store in operative communication with said server and adapted to store a plurality of characteristics of one of the plurality of printers and the plurality of display apparatuses; and
wherein said server selectively communicates each of the plurality of data structures to one of a selected printer of the plurality of printers and a selected display apparatus of the plurality of display apparatuses as a function of at least one of the plurality of characteristics.

19. The system according to claim 18, wherein the data structure includes at least one a device ID, an end user, a job characteristic, a image characteristic, a location of the one of the selected printer and the selected display apparatus, the characteristic of the one of the print data and the image data, a use of the selected printer, and a use of the selected display apparatus.

20. The system according to claim 18, the system further comprising:
an advertisement submission subsystem communicating with said server for submitting the plurality of data structures to said server.

21. The system according to claim 19, wherein said advertisement submission subsystem associates at least one advertisement characteristic with each of the plurality of data structures, and said server selectively communicates each of the plurality of data structures to one of the selected printer of the plurality of printers and the selected display apparatus of the plurality of display apparatuses as a function of one of the at least one advertisement characteristic associated with the selected one of the plurality of data structures.

22. The system according to claim 21, wherein the at least one advertisement characteristic includes at least one of a desired dimension, a desired resolution, a desired color requirement, a desired location, a desired number of printed advertisements, a prohibited advertisement location type, a desired paper quality and an advertisement type.

23. The system according to claim 22, wherein the advertisement type is one of an automobile advertisement, a healthcare advertisement, and an insurance advertisement.

24. The system according to claim 18, wherein the selected printer is selected as a function of at least one of a printer-location type, a printer-location human-traffic value, a printer capability, a printer output volume, a printed material parameter, a printer characteristic, a user characteristic and a job characteristic.

25. The system according to claim 1, further comprising:
a fleet configuration component to configure at least one parameter of the at least one of the printer and the display apparatus, wherein at least one of:
the printer prints the advertisement on the substrate in accordance with the at least one parameter; and
the display apparatus displays the advertisement in accordance with the at least one parameter.

26. The system according to claim 25, wherein the at least one parameter includes at least one of a maximum allowable dimension, a minimum allowable dimension, a maximum allowable resolution, a minimum allowable resolution, a color requirement, a cost per advertisement, a cost per pixel, a cost per printed area, a location, a minimum bid per advertisement, a minimum number of total printed advertisements, an allowable advertisement type and a prohibited advertisement type.

27. A method for selectively controlling use of functionality in one or more multifunction devices, the method comprising:
(i) communicating data to at least one of a printer and a display apparatus, wherein the data includes a data structure configured to present an advertisement;
(ii) presenting the advertisement;
(iii) generating a credit value corresponding to the presented advertisement; and
(iv) authorizing use of a predetermined amount of a function with the credit value.

28. The method according to claim 27, the method further comprising:
(v) determining a financial value from information stored on a prepaid card; and
(vi) authorizing usage of a second predetermined amount of the function, the second predetermined amount having a license value about equal to the financial value.

29. The method according to claim 27, wherein (ii) includes at least one of:
(vii) printing the advertisement on a substrate with the printer; and
(viii) displaying the advertisement on the display apparatus.
